(19) United States
(12) Patent Application Publication
(10) Pub. No.: US 2014/0145931 A1
(43) Pub. Date: May 29, 2014

(54) APPARATUS AND METHOD FOR CONTROLLING MULTI-MODAL HUMAN-MACHINE INTERFACE (HMI)

(71) Applicant: Electronics and Telecommunications Research Institute, Daejeon (KR)

(72) Inventors: Jin Woo KIM, Daejeon (KR); Tae Man HAN, Daejeon (KR)

(73) Assignee: Electronics and Telecommunications Research Institute, Daejeon (KR)

(21) Appl. No.: 14/012,461

(22) Filed: Aug. 28, 2013

(30) Foreign Application Priority Data
Nov. 28, 2012 (KR) 10-2012-0136196

(51) Int. Cl. G06F 3/16

(52) U.S. Cl. CPC G06F 3/167
USPC 345/156

(57) ABSTRACT

Provided are an apparatus and method for controlling a multi-modal human-machine interface (HMI) generating a multi-modal control signal based on the voice information and the gesture information, selecting an object from among at least one object recognized in a direction of an LOS of the user based on the multi-modal control signal, and displaying object-related information associated with the selected object based on the multi-modal control signal.

### CROSS-REFERENCE TO RELATED APPLICATION

This application claims the priority benefit of Korean Patent Application No. 10-2012-0136196, filed on Nov. 28, 2012, in the Korean Intellectual Property Office, the disclosure of which is incorporated herein by reference.

### BACKGROUND

1. Field of the Invention

Embodiments of the present invention relate to an apparatus and method for controlling a human-machine interface (HMI) by amalgamating a voice and a gesture of a driver while the driver is driving a vehicle.

2. Description of the Related Art

Voice recognition-based user interfaces and a gesture recognition-based user interfaces are being adopted in existing multi-modal interfaces for a vehicular HMI, based on different respective uses.

However, the existing multi-modal interfaces may merely ensure control of a predetermined small number of multimedia contents and thus, may not provide a user with an efficient user experience (UX) in which a voice recognition-based user interface and a gesture recognition-based user interface are combined.

Further, amalgamation of a voice recognition and a gesture recognition technology is being adopted in the fields of smart devices, virtual reality, and wearable computing technology. However, although a vehicular interactive user interface for combining a voice and a gesture is considered a top priority for safety, such a technology has yet to be realized.

Currently, active research is being conducted on a vehicular augmented reality, in order to provide information directly to a driver and a user by augmenting a three-dimensional (3D) object on a glass windshield, based on a head-up display (HUD) and a transparent display. Also, a technology for directly providing driving information to a driver by utilizing a vehicular HMI is required.

To realize the vehicular augmented reality, changing a method of separately recognizing a voice or a method of unilaterally providing information without driver interaction is required.

### SUMMARY

According to an aspect of the present invention, there is provided an apparatus for controlling a multi-modal human-machine interface (HMI) including a voice recognizer to recognize voice information associated with a voice of a user, a gesture recognizer to recognize gesture information associated with a gesture of the user, a multi-modal engine unit to generate a multi-modal control signal based on the voice information and the gesture information, an object selector to select an object from among at least one object recognized in a direction of a line of sight (LOS) of the user based on the multi-modal control signal, and a display unit to display object-related information about the selected object based on the multi-modal control signal.

The apparatus for controlling a multi-modal human-machine interface may further include an LOS recognizer to recognize an LOS of the user.

The LOS recognizer may calculate a focal distance at which the user gazes at the selected object, based on a movement speed of the selected object.

The LOS recognizer may calculate a focal distance at which the user gazes at the selected object, based on a distance between the selected object and a vehicle being driven by the user.

The apparatus for controlling a multi-modal human-machine interface may further include an object recognizer to recognize an object located ahead of a vehicle being driven by the user, and a lane recognizer to recognize a lane in which a vehicle corresponding to the object is traveling.

The apparatus for controlling a multi-modal human-machine interface may further include a user experience (UX) analyzer to analyze UX information by collecting the multi-modal control signal.

The multi-modal engine unit may generate the multi-modal control signal to select and move the object based on the UX information.

The object selector may select the object corresponding to the gesture information at a point in time at which the voice information is recognized.

The display unit may display the object-related information using an augmented reality method.

The object-related information may include at least one of a distance between a vehicle being driven by the user and the selected object, a movement speed of the selected object, and a lane in which a vehicle corresponding to the object is traveling.

According to another aspect of the present invention, there is provided a method of controlling an HMI including recognizing voice information associated with a voice of a user, recognizing gesture information associated with a gesture of the user, generating a multi-modal control signal based on the voice information and the gesture information, selecting an object from among at least one object recognized in a direction of an LOS of the user based on the multi-modal control signal, and displaying object-related information associated with the selected object based on the multi-modal control signal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of an apparatus for controlling a multi-modal human-machine interface (HMI) according to an embodiment of the present invention;

FIG. 2 is a block diagram illustrating a detailed configuration of an apparatus for controlling a multi-modal HMI according to an embodiment of the present invention;

FIG. 3 is a view illustrating an example of selecting an object located ahead of a vehicle in which an apparatus for controlling a multi-modal HMI is installed and displaying object-related information of the selected object according to an embodiment of the present invention; and

FIG. 4 is a flowchart illustrating a method of controlling a multi-modal HMI according to an embodiment of the present invention.

### DETAILED DESCRIPTION

Reference will now be made in detail to exemplary embodiments of the present invention, examples of which are illustrated in the accompanying drawings. The embodiments herein and the various features and advantageous details thereof are explained more fully with reference to the non-limiting embodiments that are illustrated in the accompanying drawings and detailed in the following description.

When it is determined detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification.

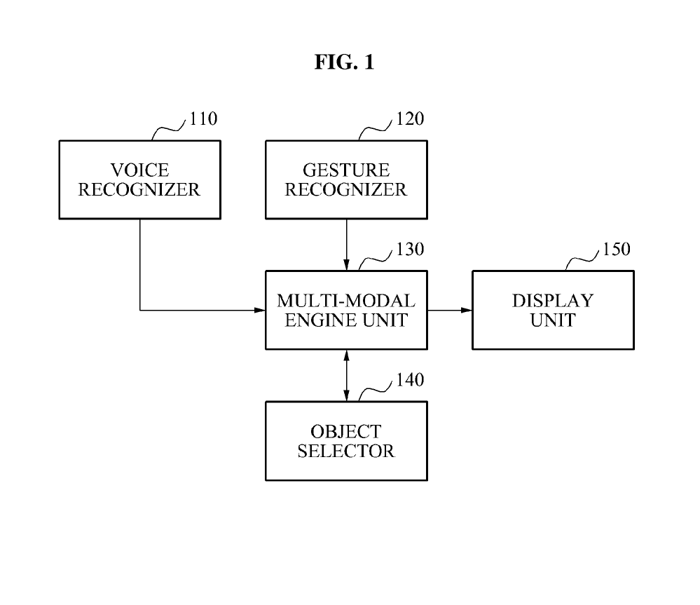

FIG. 1 is a block diagram illustrating a configuration of an apparatus for controlling a multi-modal human-machine interface (HMI) according to an embodiment of the present invention.

Referring to FIG. 1, the apparatus for controlling a multi-modal HMI according to an embodiment of the present invention may include a voice recognizer 110, a gesture recognizer 120, a multi-modal engine unit 130, an object selector 140, and a display unit 150.

The voice recognizer 110 may recognize voice information associated with a voice of a user, and the gesture recognizer 120 may recognize gesture information associated with a gesture of the user.

The multi-modal engine unit 130 may generate a multi-modal control signal based on the voice information and the gesture information, and the object selector 140 may select an object from among at least one object recognized in a direction of a line of sight (LOS) of the user based on the multi-modal control signal.

The display unit 150 may display object-related information associated with the object selected based on the multi-modal control signal. In this instance, the display unit 150 may display the object-related information including a distance between the selected object and a vehicle being driven by the user, a movement speed of the selected object, a lane in which a vehicle corresponding to the object is traveling, and the like, using an augmented reality method.

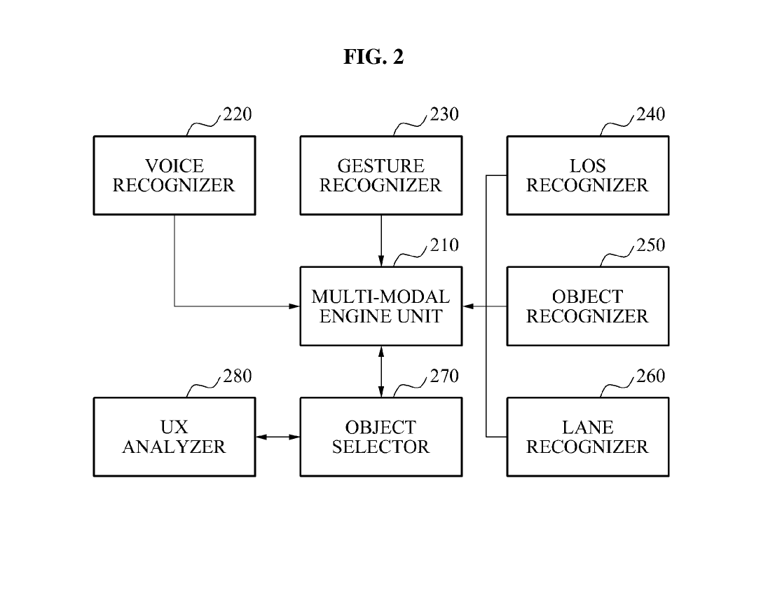

FIG. 2 is a block diagram illustrating a detailed configuration of an apparatus for controlling a multi-modal HMI according to an embodiment of the present invention.

Referring to FIG. 2, a multi-modal engine unit 210 included in the apparatus for controlling a multi-modal HMI according to an embodiment of the present invention may receive voice information recognized by a voice recognizer 220 and gesture information recognized by a gesture recognizer 230, and generate a multi-modal control signal.

The apparatus for controlling a multi-modal HMI may further include an LOS recognizer 240. The LOS recognizer 240 may recognize an LOS of a user and provide information associated with the recognized LOS of the user to the multi-modal engine unit 210.

The LOS recognizer 240 may calculate a focal distance at which the user gazes at a selected object, based on a movement speed of the selected object, and also calculate the focal distance at which the user gazes at the selected object, based on a distance between the selected object and a vehicle being driven by the user.

The apparatus for controlling a multi-modal HMI may further include an object recognizer 250 to recognize an object located ahead of a vehicle being driven by the user, and a lane recognizer 260 to recognize a lane in which a vehicle corresponding to the object is traveling. Information associated with the recognized object, the recognized lane, and the like, may be provided to the multi-modal engine unit 210 and be used to select or move the object.

The apparatus for controlling a multi-modal HMI may further include a user experience (UX) analyzer 280 to analyze UX information by collecting the multi-modal control signal. The UX analyzer 280 may provide the analyzed UX information to an object selector 270 so that the analyzed UX information may be used as reference information for selecting the object.

In this instance, the multi-modal engine unit 210 may generate a multi-modal control signal for selecting and moving the object based on the UX information. The object selector 270 may select the object corresponding to gesture information at a point in time at which the voice information is recognized.

In terms of realizing a vehicular augmented reality, a reason for augmenting three-dimensional (3D) content by using a head-up display (HUD), a projecting method, and a transparent display method is to extend an LOS of a driver from a range of few meters to a range of tens of meters.

The apparatus for controlling a multi-modal HMI according to an embodiment of the present invention may adopt a principle that enables a driver to indicate an object, such as another vehicle, a person, and a material, for example, located ahead of a vehicle by pointing to the object or designating a predetermined stationary hand motion using a hand of a driver at a location corresponding to a current LOS of the driver.

According to an embodiment of the present invention, when a driver encounters an to extreme or a complex situation while driving, during which an LOS of the driver is virtually stationary, the driver may control an HMI of a vehicle while maintaining stable driving conditions. For example, when the driver points to an object at a location corresponding to the LOS of the driver using a hand, a leading vehicle or a material in the approaching vicinity nearest to a matching point between the hand and the LOS may be augmented.

The apparatus for controlling a multi-modal HMI may calculate a display distance between a single point pointed to with a hand and a location of a leading vehicle in the form of a line, to obtain a focal distance with respect to an initial LOS of a driver.

The apparatus for controlling a multi-modal HMI may operate in various modes when an object moves, for example, when a leading vehicle or a predetermined object suddenly turns in an X or Y direction.

For example, the apparatus for controlling a multi-modal HMI may track a selected object as a leading vehicle on a lane or maintain a focal location in a front perspective view. The apparatus for controlling a multi-modal HMI may be controlled to calculate an LOS of a driver based on a speed in a similar manner in which the HUD augments an object to be located at a few meters ahead, without variation.

When a vehicle aside from a leading vehicle that previously moved out of view comes into a view of the driver, the apparatus for controlling a multi-modal HMI may track the vehicle as a leading vehicle and calculate a focal distance by using a distance from the leading vehicle as a new variable.

A driver may drive a vehicle without continuously verifying information associated with driving or information associated with an augmented object displayed on the HUD because the driver may need to simultaneously drive and verify conditions ahead and an environment around the vehicle. When an LOS of the driver is directed toward the augmented object on a windshield of the vehicle while concentrating on driving, the apparatus for controlling a multi-modal HMI may minimize degrees of an LOS dispersion and a unfamiliarity by augmenting the object at an actual location of the leading vehicle. In this instance, the driver may drive while continuously keeping track of a leading vehicle, and avoid the LOS dispersion by simultaneously verifying the leading vehicle and a material around the leading vehicle.

When a location of the leading vehicle or the other object changes, the apparatus for controlling a multi-modal HMI may serve to predict that an augmented object displayed on a windshield is suddenly erroneous, and correct object-related information being displayed. For example, when the leading vehicle and a lane are selected to be objects, the apparatus for controlling a multi-modal HMI may linearly estimate conditions under which a distance between the leading vehicle and the vehicle of the driver become gradually closer, and correct the object-related information, based on a result of the linear estimation.

The apparatus for controlling a multi-modal HMI may set an initial moment when an LOS of a user corresponds to a selected object, and select or move an object based on an intuitive UX of the driver.

For example, when a user points to an object or gestures using a stationary motion to indicate an object, and concurrently commands object recognition with a voice through a voice recognition mode, the apparatus for controlling a multi-modal HMI may track the corresponding object. In this instance, the apparatus for controlling a multi-modal HMI may calculate a momentary focal distance based on the recognized gesture and voice of the user, and improve an accuracy of the calculated focal distance by calculating the focal distance based on speed information of the leading vehicle.

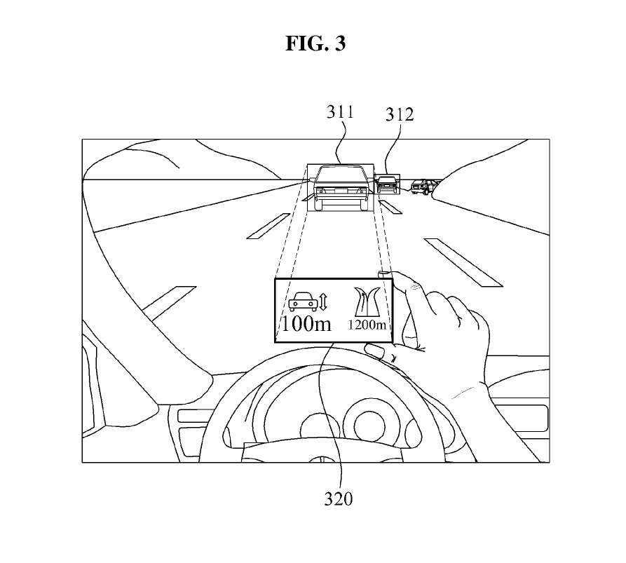

FIG. 3 is a view illustrating an example of selecting an object located ahead of a vehicle in which an apparatus for controlling a multi-modal HMI is installed, and displaying object-related information of the selected object according to an embodiment of the present invention.

Referring to FIG. 3, in a situation in which a user drives a vehicle while intuitively gazing at leading vehicles 311 and 312, the user may indicate a desired object, for example, the leading vehicle 311 with a stationary hand motion. In this case, the user may verify object-related information 320 about an object to be augmented.

In addition, the apparatus for controlling a multi-modal HMI may receive information associated with a distance between the leading vehicles 311 and 312 from an external vehicle recognition system, and calculate a focal distance from which a driver actually gazes by matching a distance of a selected vehicle and the distance between the leading vehicles 311 and 312.

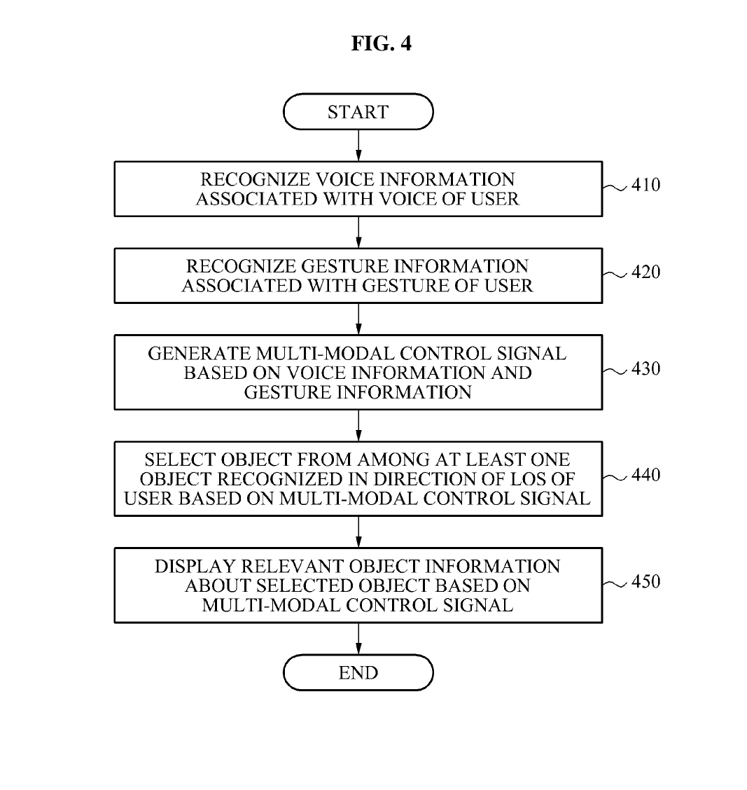

FIG. 4 is a flowchart illustrating a method of controlling a multi-modal HMI according to an embodiment of the present invention.

Referring to FIG. 4, an apparatus for controlling a multi-modal HMI may recognize voice information associated with a voice of a user in operation 410, and recognize gesture information associated with a gesture of the user in operation 420.

The apparatus for controlling a multi-modal HMI may generate a multi-modal control signal based on the voice information and the gesture information in operation 430, and select an object from among at least one object recognized in a direction of an LOS of the user based on the multi-modal control signal in operation 440.

The apparatus for controlling a multi-modal HMI may display object-related information associated with the object selected based on the multi-modal control signal in operation 450.

The apparatus for controlling a multi-modal HMI may provide a UX based engine structure for optimizing a distance of an LOS of a driver by detecting a vehicle located in a middle ahead, based on the LOS of the driver and a driving direction.

The apparatus for controlling a multi-modal HMI may further include a multi-modal engine unit to synthetically control a driver gesture motion recognition and a driver voice recognition, and a rendering engine to calculate and display a focal distance between an object and a driver projected on a glass windshield of a vehicle, based on an interior and an exterior of the vehicle and an LOS recognition of the driver.

The apparatus for controlling a multi-modal HMI may collect and analyze UX information using a real-time UX analyzer, and intuitively provide object-related information for displaying on an augmented object or a display when a driver operates a user interface (UI).

According to an embodiment of the present invention, there may be provided a real-time rendering technology that enables a driver to avoid losing an LOS and being dispersed a focus while driving and watching contents displayed on a glass windshield of a vehicle by using a natural user interface (NUI).

According to an embodiment of the present invention, there may be provided an integrated HMI engine that may integrate tracking an LOS of a driver, a real-time focal distance calculation, a gesture recognition, a voice recognition, and a vehicle external environment recognition.

According to an embodiment of the present invention, there may be provided adaptive HMI information to a driver, and an HMI user interface (UI) and an HMI UX for handling the information.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program to instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for controlling a multi-modal human-machine interface (HMI), the apparatus comprising:
a voice recognizer to recognize voice information associated with a voice of a user;
a gesture recognizer to recognize gesture information associated with a gesture of the user;
a multi-modal engine unit to generate a multi-modal control signal based on the voice information and the gesture information;
an object selector to select an object from among at least one object recognized in a direction of a line of sight (LOS) of the user based on the multi-modal control signal; and
a display unit to display object-related information about the selected object based on the multi-modal control signal.

2. The apparatus of claim 1, further comprising:
an LOS recognizer to recognize an LOS of the user.

3. The apparatus of claim 2, wherein the LOS recognizer calculates a focal distance at which the user gazes at the selected object, based on a movement speed of the selected object.

4. The apparatus of claim 2, wherein the LOS recognizer calculates a focal distance at which the user gazes at the selected object, based on a distance between the selected object and a vehicle being driven by the user.

5. The apparatus of claim 1, further comprising:
an object recognizer to recognize an object located ahead of a vehicle being driven by the user; and
a lane recognizer to recognize a lane in which a vehicle corresponding to the object is traveling.

6. The apparatus of claim 1, further comprising:
a user experience (UX) analyzer to analyze UX information by collecting the multi-modal control signal.

7. The apparatus of claim 6, wherein the multi-modal engine unit generates the multi-modal control signal to select and move the object based on the UX information.

8. The apparatus of claim 1, wherein the object selector selects the object corresponding to the gesture information at a point in time at which the voice information is recognized.

9. The apparatus of claim 1, wherein the display unit displays the object-related information using an augmented reality method.

10. The apparatus of claim 1, wherein the object-related information comprises at least one of a distance between a vehicle being driven by the user and the selected object, a movement speed of the selected object, and a lane in which a vehicle corresponding to the object is traveling.

11. A method of controlling a multi-modal human-machine interface (HMI), the method comprising:
recognizing voice information associated with a voice of a user;
recognizing gesture information associated with a gesture of the user;
generating a multi-modal control signal based on the voice information and the gesture information;
selecting an object from among at least one object recognized in a direction of a line of sight (LOS) of the user based on the multi-modal control signal; and
displaying object-related information associated with the selected object based on the multi-modal control signal.

12. The method of claim 11, further comprising:
recognizing an LOS of the user.

13. The method of claim 12, wherein the recognizing comprises calculating a focal distance at which the user gazes at the selected object, based on a movement speed of the selected object.

14. The method of claim 12, wherein the recognizing comprises a calculating a focal distance at which the user gazes at the selected object, based on a distance between the selected object a vehicle being driven by the user.

15. The method of claim 11, further comprising:
a recognizing an object located ahead of a vehicle being driven by the user; and
a recognizing a lane in which a vehicle corresponding to the object is traveling.

16. The method of claim 11, further comprising:
analyzing user experience (UX) information by collecting the multi-modal control signal.

17. The method of claim 16, further comprising:
generating the multi-modal control signal to select and move the object based on the UX information.

18. The method of claim 11, wherein the selecting comprises selecting the object corresponding to the gesture information at a point in time at which the voice information is recognized.

19. The method of claim 11, wherein the displaying comprises displaying the object-related information using an augmented reality method.

20. The method of claim 11, wherein the object-related information comprises at least one of a distance between a vehicle being driven by the user and the selected object, a movement speed of the selected object, and a lane in which a vehicle corresponding to the object is traveling.
